(19) United States
(12) Patent Application Publication
(10) Pub. No.: US 2026/0225568 A1
(43) Pub. Date: Aug. 6, 2026

(54) BRAKE ACTUATOR

(71) Applicant: HYUNDAI MOBIS CO., LTD., Seoul (KR)

(72) Inventor: Chang Hoe KOO, Yongin-si, Gyeonggi-do (KR)

(73) Assignee: HYUNDAI MOBIS CO., LTD., Seoul (KR)

(21) Appl. No.: 19/440,801

(22) Filed: Jan. 6, 2026

(30) Foreign Application Priority Data
Feb. 4, 2025 (KR) 10-2025-0014103
Sep. 17, 2025 (KR) 10-2025-0133798

(51) Int. Cl. B60T 13/74; B60T 8/40

(52) U.S. Cl. CPC B60T 13/745; B60T 8/4081

(57) ABSTRACT

A brake actuator according to the present disclosure includes a hydraulic unit including a cylinder hole formed to extend in a first direction, with a hydraulic circuit provided in the hydraulic unit, a cylinder unit including a cylinder disposed to pass through the cylinder hole, and a piston configured to move inside the cylinder, a drive unit disposed on a side of the hydraulic unit, and configured to move the piston, and an electronic control unit disposed on another side of the hydraulic unit.

### CROSS-REFERENCE TO RELATED APPLICATION

The present application claims priority and the benefit of Korean Patent Application No. 10-2025-0014103, filed on February 4, 2025 and No. 10-2025-0133798, filed on September 17, 2025 in the Korean Intellectual Property Office, the entire disclosure of which is incorporated herein by reference.

### BACKGROUND

### Field

Exemplary embodiments of the present disclosure relate to brake actuators, and more particularly, to a modularized brake actuator.

### Discussion Of The Background

A traveling vehicle may be braked by using a brake apparatus. The brake apparatus may increase braking force by amplifying a user's input force using hydraulic pressure and a vacuum assist force. The vacuum assist force may be generated by using output from an engine of the vehicle. However, a problem arises in that the use of the vacuum assist force reduces the output of the engine.

In order to solve the above problem, an electric brake apparatus that increases a user's input force by using a motor driven by electrical energy, instead of using output from an engine, is used. Such an electric brake apparatus includes a motor, an electronic control unit, and the like. However, there is a problem in that the need to vary the capacity of the motor depending on the size of the vehicle complicates the design, and malfunctioning components are not readily repairable.

The background art of the present disclosure is disclosed in Japanese Patent No. 5501386 (registered on Mar. 20, 2014, entitled “ELECTRIC BRAKE BOOSTER AND BRAKE APPARATUS USING THE SAME”).

### SUMMARY

Various embodiments are directed to providing a brake actuator with variable fluid discharge capacity.

Various embodiments are directed to providing a brake actuator with improved maintainability.

In an embodiment, a brake actuator may include: a hydraulic unit including a cylinder hole formed to extend in a first direction, with a hydraulic circuit provided in the hydraulic unit; a cylinder unit including a cylinder disposed to pass through the cylinder hole, and a piston configured to move inside the cylinder; a drive unit disposed on a side of the hydraulic unit, and configured to move the piston; and an electronic control unit disposed on another side of the hydraulic unit.

The hydraulic unit may include a pedal hole formed to extend in a second direction different from the first direction. The brake actuator may further include a pedal unit inserted into the pedal hole.

The pedal unit may include a pedal stroke inserted into the pedal hole and configured to move in the pedal hole. The hydraulic unit may include a stroke sensor configured to detect a position of the pedal stroke.

The brake actuator may further include a spacer unit disposed between the drive unit and the hydraulic unit and configured to provide a space between the drive unit and the hydraulic unit.

The spacer unit may include: a spacer body disposed between the drive unit and the hydraulic unit; a spacer fastening hole passing through the spacer body; and a spacer fastener passing through the drive unit and the spacer fastening hole, and inserted into the hydraulic unit.

The brake actuator may further include: a spacer body terminal hole into which the cylinder unit is inserted; a spacer-body inner contact portion disposed inside the spacer body terminal hole and contacting the cylinder unit; and a spacer body connection portion connecting the spacer body and the spacer body terminal hole.

The brake actuator may further include: a spacer body protrusion protruding from the spacer body connection portion toward the drive unit; and a spacer body protrusion groove formed as a groove in the spacer body protrusion and engaged with the drive unit.

The drive unit may include: a drive housing including an opening that is open toward the hydraulic unit; and a motor disposed in the drive housing.

The drive unit may include: a drive protrusion disposed to protrude from the drive housing; and a drive protrusion bearing disposed in the drive protrusion, and configured to contact the cylinder unit.

The drive unit may include: an open support disposed in the opening; and an open support bearing disposed between the open support and the cylinder unit, and configured to contact the cylinder unit.

The brake actuator may further include: the opening into which the cylinder unit is inserted; an open support bearing disposed radially outside the opening; an open support disposed radially outside the open support bearing and configured to support the open support bearing; an open support protrusion protruding from the open support toward the spacer unit and engaging with the spacer unit.

The piston may move toward and away from the electronic control unit and cause fluid in the cylinder unit to flow.

The cylinder unit may further include a piston driver disposed in the cylinder and configured to be rotated by the drive unit. The piston may be moved between the drive unit and the electronic control unit by rotation of the piston driver.

A brake actuator according to the present disclosure enables fluid discharge capacity to be varied.

Furthermore, the brake actuator according to the present disclosure enables improved maintainability.

### BRIEF DESCRIPTION OF THE DRAWINGS

FIG. 1 is a perspective view illustrating a brake actuator according to an embodiment of the present disclosure.

FIG. 2 is a perspective view illustrating the brake actuator according to an embodiment of the present disclosure.

FIG. 3 is an exploded perspective view illustrating the brake actuator according to an embodiment of the present disclosure as viewed from a first viewpoint.

FIG. 4 is an exploded perspective view illustrating the brake actuator according to an embodiment of the present disclosure as viewed from a second viewpoint.

FIG. 5 is a perspective view illustrating a cylinder unit, a drive unit, and a spacer unit according to various embodiments of the present disclosure.

FIG. 6 is a sectional view illustrating the drive unit according to an embodiment of the present disclosure.

FIG. 7 is a sectional view illustrating the cylinder unit according to a first embodiment of the present disclosure.

FIG. 8 is a sectional view illustrating the cylinder unit according to a second embodiment of the present disclosure.

FIG. 9 is an exploded perspective view illustrating a brake actuator including a modified example of a spacer unit according to the present disclosure.

FIG. 10 is a perspective view illustrating a modified example of the spacer unit of the present disclosure.

FIG. 11 is a perspective view illustrating a modified example of the drive unit of the present disclosure.

FIG. 12 is a sectional view illustrating a drive unit combined with a modified example of the spacer unit of the present disclosure.

### DETAILED DESCRIPTION OF THE ILLUSTRATED EMBODIMENTS

Hereinafter, a brake actuator according to an embodiment of the present disclosure will be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the present disclosure into account and can be changed according to the custom or intention of users or operators. Therefore, definition of the terms should be made according to the overall disclosures set forth herein.

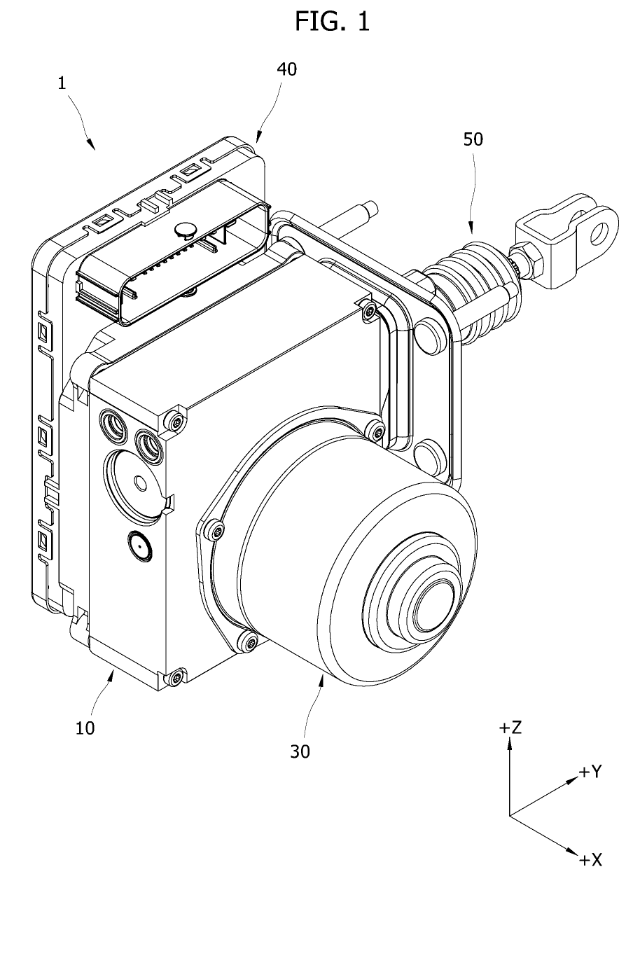

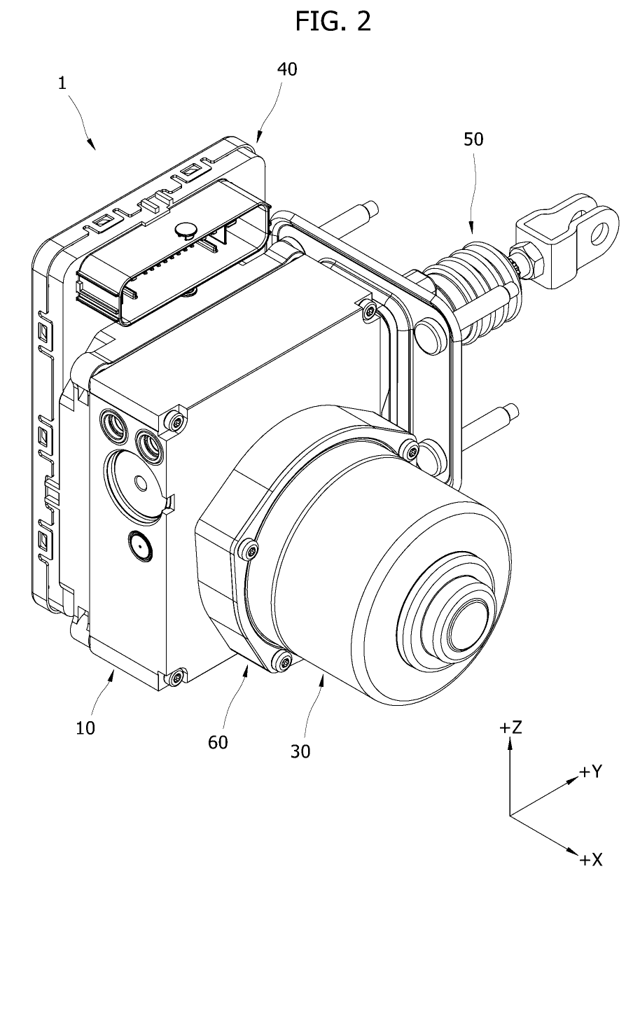

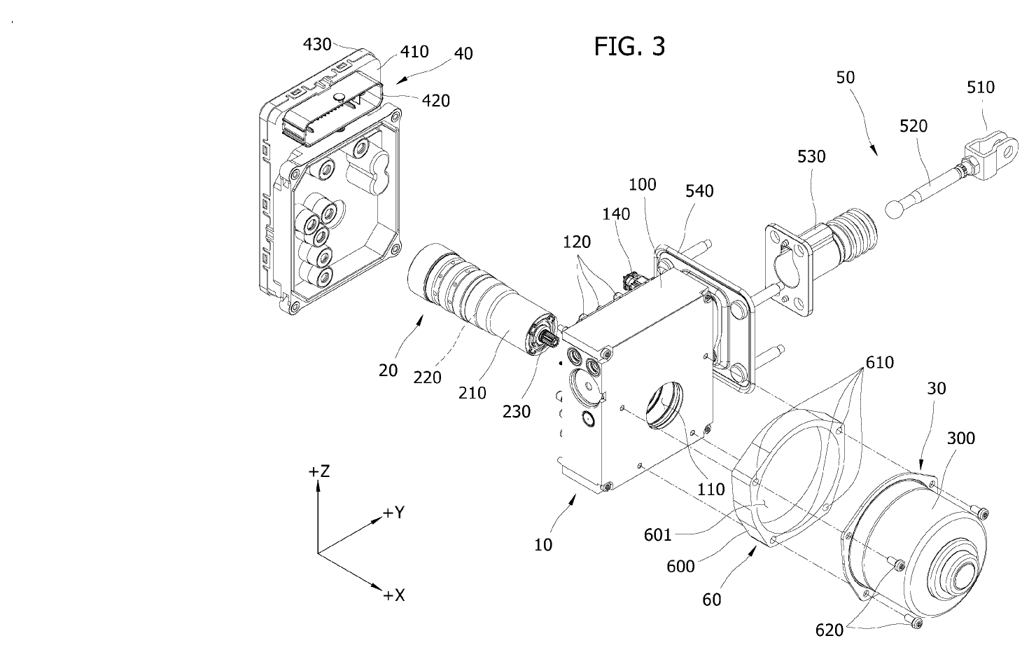

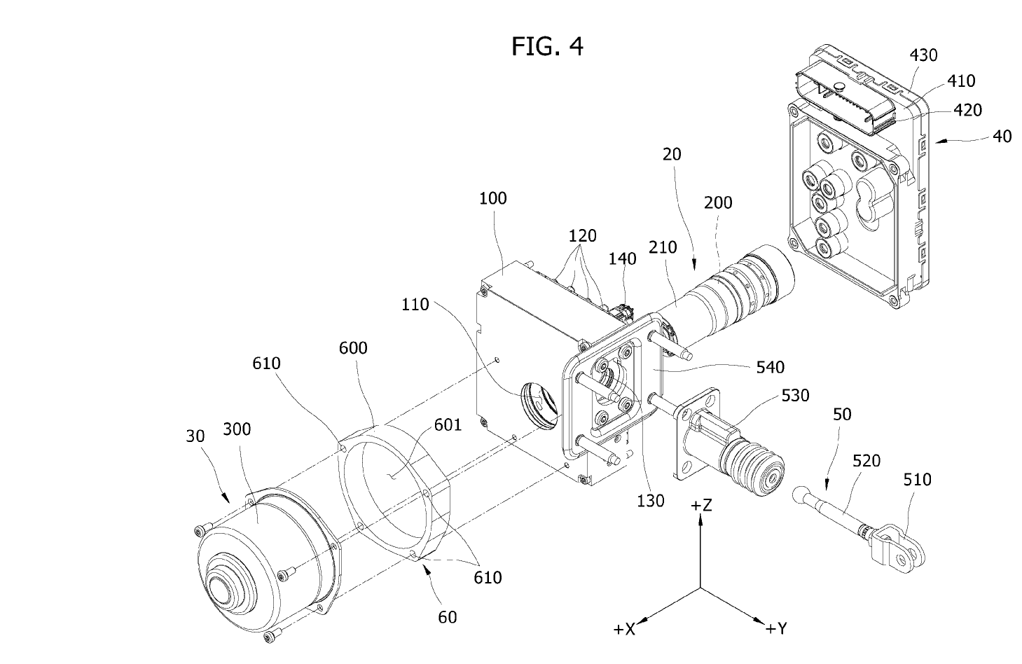

FIG. 1 is a perspective view illustrating a brake actuator 1 according to an embodiment of the present disclosure. FIG. 2 is a perspective view illustrating the brake actuator 1 according to an embodiment of the present disclosure. FIG. 3 is an exploded perspective view illustrating the brake actuator 1 according to an embodiment of the present disclosure as viewed from a first viewpoint. FIG. 4 is an exploded perspective view illustrating the brake actuator 1 according to an embodiment of the present disclosure as viewed from a second viewpoint.

The brake actuator 1 will be described with reference to FIGS. 1 to 4.

The brake actuator 1 may include a hydraulic unit 10, a cylinder unit 20, a drive unit 30, and an electronic control unit 40. The brake actuator 1 may further include a pedal unit 50 and/or a spacer unit 60.

The hydraulic unit 10 may receive fluid therein. Depending on the flow and pressure of the fluid, braking force applied to wheels of a vehicle may vary. In an embodiment, the hydraulic unit 10 may individually control braking force applied to each of the wheels of the vehicle.

The cylinder unit 20 may be disposed in the hydraulic unit 10. In an embodiment, the cylinder unit 20 may be inserted into a cylinder hole 110 passing through a hydraulic housing 100 of the hydraulic unit 10. The cylinder unit 20 inserted into the cylinder hole 110 may move the fluid received in the hydraulic unit 10 and/or control pressure of the fluid.

The drive unit 30 may be disposed on a first side (e.g., in a +X-axis direction) of the hydraulic unit 10. The drive unit 30 may generate a driving force. The drive unit 30 may be connected to the cylinder unit 20. The driving force generated from the drive unit 30 may be transmitted to the cylinder unit 20, and the cylinder unit 20 may operate by the driving force. The operation of the cylinder unit 20 may cause fluid to move into and out of the cylinder unit 20.

The electronic control unit 40 may be disposed on a second side (e.g., in a −X-axis direction) of the hydraulic unit 10. In an embodiment, the hydraulic unit 10 may be disposed between the electronic control unit 40 and the drive unit 30. The electronic control unit 40 may control the driving force of the drive unit 30 to control the operation of the cylinder unit 20.

The pedal unit 50 may be disposed on a third side (e.g., in a +Y-axis direction) of the hydraulic unit 10. In an embodiment, the pedal unit 50 may be inserted into a pedal hole 130 formed in a hydraulic housing 100 of the hydraulic unit 10. The pedal unit 50 inserted into the pedal hole 130 may move inside the hydraulic unit 10 in response to movement of the user. A stroke sensor 140 may be disposed in the hydraulic unit 10 to detect a position of the pedal unit 50. In an embodiment, the stroke sensor 140 may detect a position of a pedal stroke 520 of the pedal unit 50. Information on the position of the pedal stroke 520 detected by the stroke sensor 140 may be transmitted to the electronic control unit 40. The electronic control unit 40 may receive the information on the position of the pedal stroke 520 and may control the driving force of the drive unit 30 based on the information. Accordingly, the cylinder unit 20 may operate so that fluid received in the hydraulic unit 10 may move or the pressure of the fluid may be adjusted.

The spacer unit 60 may be disposed on the first side (e.g., in the +X-axis direction) of the hydraulic unit 10. In an embodiment, the spacer unit 60 may be disposed between the hydraulic unit 10 and the drive unit 30. The spacer unit 60 disposed between the hydraulic unit 10 and the drive unit 30 may provide a space between the hydraulic unit 10 and the drive unit 30. A distance by which the hydraulic unit 10 and the drive unit 30 are spaced apart may be adjusted based on a height (e.g., in the X-axis direction) of the spacer unit 60.

Based on an increase in the height of the spacer unit 60, the distance between the hydraulic unit 10 and the drive unit 30 may increase, and accordingly, a length (e.g., in the X-axis direction) of the cylinder unit 20 may increase. Therefore, the cylinder unit 20 having a relatively large length may be disposed in the hydraulic unit 10.

Based on a reduction in the height of the spacer unit 60, the distance between the hydraulic unit 10 and the drive unit 30 may decrease, and accordingly, the length of the cylinder unit 20 may decrease. Therefore, the cylinder unit 20 having a relatively small length may be disposed in the hydraulic unit 10.

As described above, the cylinder unit 20 having various sizes may be disposed in the hydraulic unit 10 according to a change in the length of the spacer unit 60. As the cylinder unit 20 having various sizes is disposed in the hydraulic unit 10, the brake actuator 1 may be mounted to different types of vehicles by replacing the cylinder unit 20 and/or the spacer unit 60 with one having a different size.

In an embodiment, the spacer unit 60 having a large height (e.g., in the X-axis direction) and the cylinder unit 20 having a large length (e.g., in the X-axis direction) may be disposed in the hydraulic unit 10 to increase the output of the brake actuator 1.

According to another embodiment, the spacer unit 60 having a small height (e.g., in the X-axis direction) and the cylinder unit 20 having a small length may be disposed in the hydraulic unit 10 to reduce the output of the brake actuator 1.

As described above, as the height (e.g., in the X-axis direction) of the spacer unit 60 is adjusted, the length (e.g., in the X-axis direction) of the cylinder unit 20 may be adjusted. Accordingly, the fluid discharge capacity of the cylinder unit 20 may be adjusted, and the need to redesign the brake actuator 1 for application to various vehicles may be minimized.

Referring to FIGS. 1 to 4, a detailed configuration of the brake actuator 1 will be described.

The hydraulic unit 10 may include the hydraulic housing 100, the cylinder hole 110, a hydraulic circuit 120, the pedal hole 130, and the stroke sensor 140.

The hydraulic housing 100 may be provided in an approximately hexahedral shape. In an embodiment, the hydraulic housing 100 may have a rectangular parallelepiped shape.

The cylinder hole 110 may be formed as a hole passing through the hydraulic housing 100. In an embodiment, the cylinder hole 110 may pass through the hydraulic housing 100 in a direction (e.g., in the X-axis direction). The cylinder unit 20 may be disposed in the cylinder hole 110. In an embodiment, the cylinder unit 20 may be disposed to pass through the cylinder hole 110. A first side (e.g., in the +X-axis direction) of the cylinder unit 20 may contact the drive unit 30, and a second side (e.g., in the −X-axis direction) of the cylinder unit 20 may be disposed to face the electronic control unit 40.

The hydraulic circuit 120 may be disposed in the hydraulic unit 10. In an embodiment, the hydraulic circuit 120 may be disposed inside the hydraulic housing 100. The hydraulic circuit 120 may form a flow path through which fluid received in the hydraulic unit 10 moves. A portion of the hydraulic circuit 120 may be opened or closed so that a flow path of the fluid can change.

According to the above configuration, the brake actuator 1 may independently transmit braking force to each wheel. As the braking force of each wheel is independently controlled, the brake actuator 1 may perform an electronic stability control function.

As the flow path is opened or closed by the electronic control unit 40, the hydraulic circuit 120 may adjust the braking force of each wheel. As the braking force of each wheel is adjusted, the brake actuator 1 may perform an anti-lock braking system function.

The pedal hole 130 may be provided as a recessed hole in the hydraulic housing 100. In an embodiment, the pedal hole 130 may be located at the third side (e.g., in the +Y-axis direction) of the hydraulic housing 100.

The pedal unit 50 may be disposed in the pedal hole 130. In an embodiment, the pedal unit 50 may be inserted into the pedal hole 130. The pedal unit 50 may move parallel to a direction (e.g., in the Y-axis direction) inside the pedal hole 130.

The stroke sensor 140 may be disposed in the hydraulic unit 10. In an embodiment, the stroke sensor 140 may be disposed in the hydraulic housing 100 to detect a position of the pedal unit 50. More specifically, the stroke sensor 140 may detect a position of the pedal stroke 520 of the pedal unit 50. The stroke sensor 140 may transmit information on the position of the pedal stroke 520 to the electronic control unit 40.

The electronic control unit 40 may control the driving force of the drive unit 30 based on information on the position of the pedal stroke 520.

The cylinder unit 20 may be disposed in the hydraulic housing 100. In an embodiment, the cylinder unit 20 may be inserted into the cylinder hole 110 formed in the hydraulic housing 100. The cylinder unit 20 may be connected to the drive unit 30 and may operate by a driving force generated from the drive unit 30.

The cylinder unit 20 may include a cylinder 210, a piston 220, and a piston driver 230.

The cylinder 210 may be provided in an approximately pipe-like shape. In an embodiment, the cylinder 210 may be provided in an approximately circular pipe-like shape. The piston 220 may be disposed inside the cylinder 210.

The piston 220 may move in a longitudinal direction (e.g., in the X-axis direction) of the cylinder 210. When the piston 220 moves in the +X-axis direction, the fluid received in the cylinder 210 may be discharged to the outside of the cylinder 210. When the piston 220 moves in the −X-axis direction, the fluid positioned outside the cylinder 210 may be introduced into the cylinder 210.

The piston driver 230 may be connected to the drive unit 30. In an embodiment, the piston driver 230 may be connected to the drive unit 30 to receive a driving force generated from the drive unit 30. The piston driver 230 may rotate using the driving force received from the drive unit 30.

When the piston driver 230 rotates, the piston 220 may move parallel to a direction (e.g., in the X-axis direction).

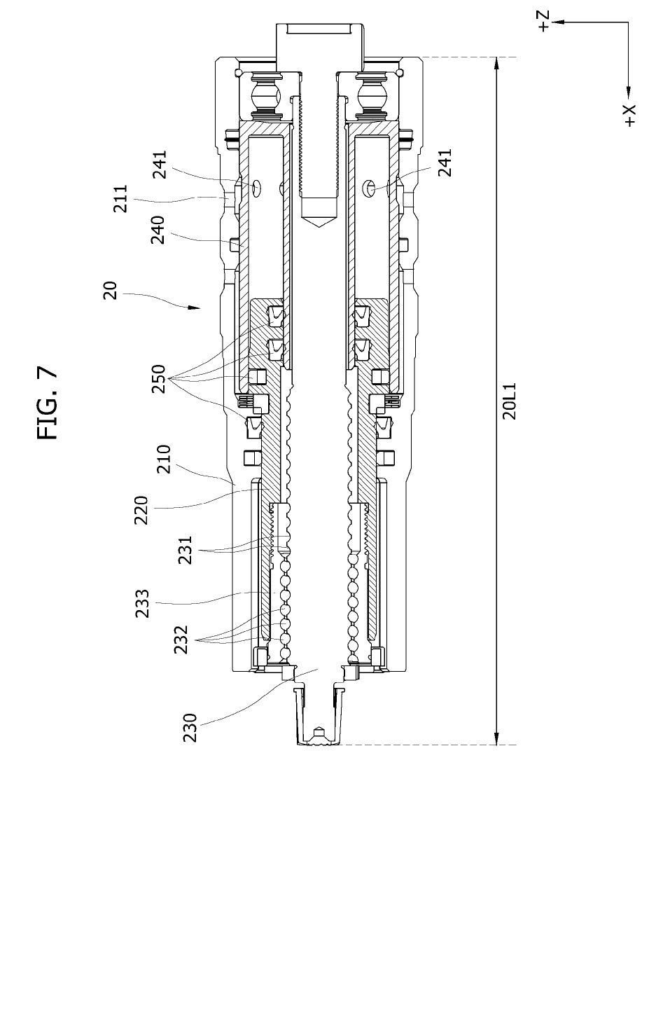

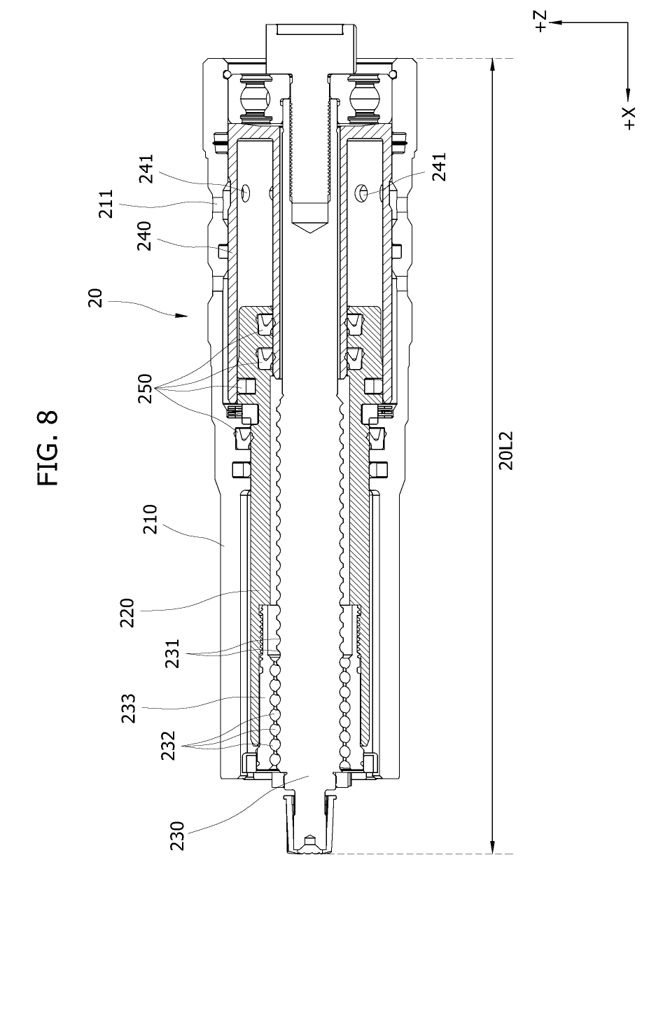

A detailed description of the cylinder unit 20 will be provided below together with descriptions of FIGS. 7 and 8.

The drive unit 30 may include a drive housing 300 and a drive protrusion 310.

The drive housing 300 may be disposed on the first side (e.g., in the +X-axis direction) of the hydraulic unit 10. A first side (e.g., located in the +X-axis direction) of the drive housing 300 may be closed, and a second side (e.g., located in the −X-axis direction) of the drive housing 300 may include an opening 301.

The drive protrusion 310 may be disposed at the closed side of the drive housing 300. The drive protrusion 310 may be formed to protrude in a direction (e.g., in the +X-axis direction).

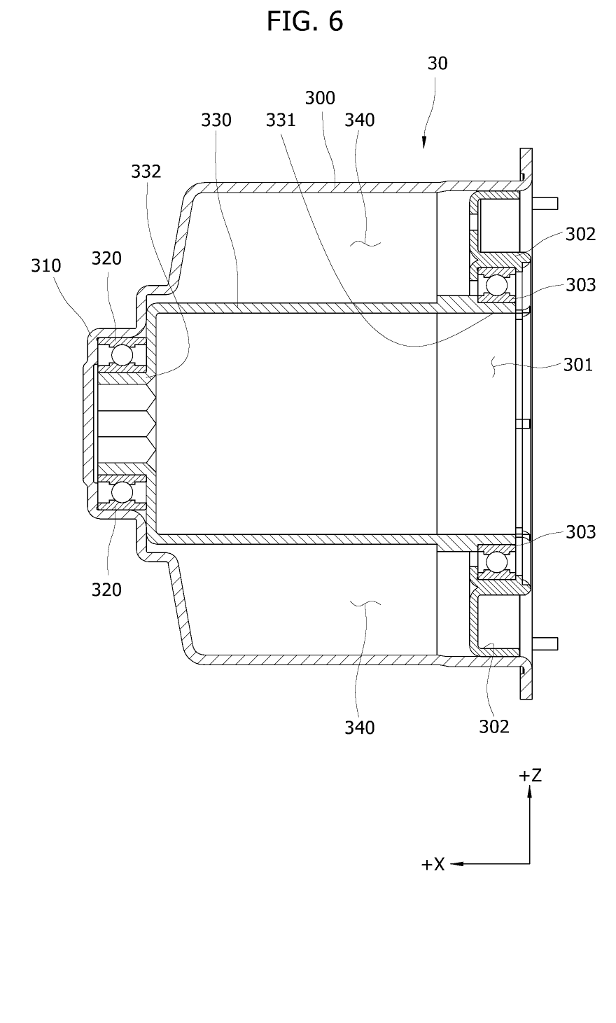

The detailed description of the drive unit 30 will be provided below together with a description of FIG. 6.

The electronic control unit 40 may be disposed on the second side (e.g., located in the −X-axis direction) of the hydraulic unit 10.

The electronic control unit 40 may receive information from the stroke sensor 140 and may control the driving force of the drive unit 30.

The electronic control unit 40 may include an electronic control unit body 410, an electronic control unit connector 420, and an electronic control unit cover 430.

A circuit board (not shown) may be disposed inside the electronic control unit body 410. The circuit board may communicate with the drive unit 30 and/or the stroke sensor 140 to transmit and receive information and signals.

The electronic control unit connector 420 may be disposed in the electronic control unit body 410. The electronic control unit body 410 may include pins configured to transmit and receive electrical signals. The electronic control unit connector 420 may be electrically connected to the circuit board disposed inside the electronic control unit body 410.

The electronic control unit cover 430 may be disposed to be coupled to the electronic control unit body 410. As the electronic control unit cover 430 is coupled to the electronic control unit body 410, foreign substances may be prevented from entering the electronic control unit 40.

The pedal unit 50 may be inserted into the hydraulic unit 10. The pedal unit 50 may move in response to movement of the user. In an embodiment, the pedal unit 50 may move parallel to a direction (e.g., in the Y-axis direction).

The pedal unit 50 may include a pedal connector 510, a pedal stroke 520, a connection support 530, and a gasket 540.

The pedal connector 510 may be coupled to a pedal (not shown) that comes into contact with the user. The pedal stroke 520 may be disposed in a direction (e.g., in the −Y-axis direction) of the pedal connector 510.

The pedal stroke 520 may be connected to the pedal connector 510 and may move parallel to a direction (e.g., in the Y-axis direction) together with the pedal connector 510. The pedal stroke 520 may be inserted into the pedal hole 130 formed in the hydraulic unit 10. The position of the pedal stroke 520 may be detected by the stroke sensor 140 of the hydraulic unit 10.

The connection support 530 may be disposed to be connected to the hydraulic unit 10. In an embodiment, the connection support 530 may be disposed on the third side (e.g., in the +Y-axis direction) of the hydraulic unit 10. The connection support 530 may be shaped to have a hollow interior. The connection support 530 may be disposed on the third side of the hydraulic unit 10 such that a position of the hollow interior of the connection support 530 corresponds to a position of the pedal hole 130 of the hydraulic unit 10.

The gasket 540 may be disposed between the connection support 530 and the hydraulic unit 10. In an embodiment, the gasket 540 may be disposed between the connection support 530 and the hydraulic housing 100. As the gasket 540 is disposed between the connection support 530 and the hydraulic housing 100, foreign substances may be prevented from entering the hydraulic unit 10 through the pedal hole 130.

The spacer unit 60 may be disposed between the hydraulic unit 10 and the drive unit 30. The spacer unit 60 disposed between the hydraulic unit 10 and the drive unit 30 may provide a space between the hydraulic unit 10 and the drive unit 30.

The spacer unit 60 may include a spacer body 600, a spacer body hole 601, a spacer fastening hole 610, and a spacer fastener 620.

The spacer body 600 may be disposed between the hydraulic unit 10 and the drive unit 30.

The spacer body hole 601 may be provided as a hole that passes through the spacer body 600. In an embodiment, the spacer body hole 601 may extend parallel to a direction (e.g., the X-axis direction) of the spacer body 600. The spacer body hole 601 may be located in a central portion of the spacer body 600. The cylinder unit 20 may be disposed to pass through the spacer body hole 601.

A height of the spacer body 600 (e.g., in the X-axis direction) may be set to various values.

In an embodiment, in the case where the cylinder unit 20 having a relatively large length (e.g., in the X-axis direction) is disposed in the hydraulic unit 10, the height of the spacer body 600 (e.g., in the X-axis direction) may be increased to correspond to the length of the cylinder unit 20.

In another embodiment, when the cylinder unit 20 having a relatively small length (e.g., in the X-axis direction) is disposed in the hydraulic unit 10, the height of the spacer body 600 (e.g., in the X-axis direction) may be reduced to correspond to the length of the cylinder unit 20.

The spacer fastening hole 610 may be provided as a hole that passes through the spacer body 600. The spacer fastening hole 610 may be disposed in a perimeter of the spacer body 600. In an embodiment, the spacer fastening hole 610 may be located farther from the central portion of the spacer body 600 than is the spacer body hole 601.

The spacer fastener 620 may be fixed to the hydraulic unit 10 by passing through the spacer fastening hole 610. In an embodiment, the spacer fastener 620 may be fixed to the hydraulic unit 10 through both the drive housing 300 and the spacer fastening hole 610. Accordingly, the drive unit 30 and the spacer unit 60 may be secured to the hydraulic unit 10.

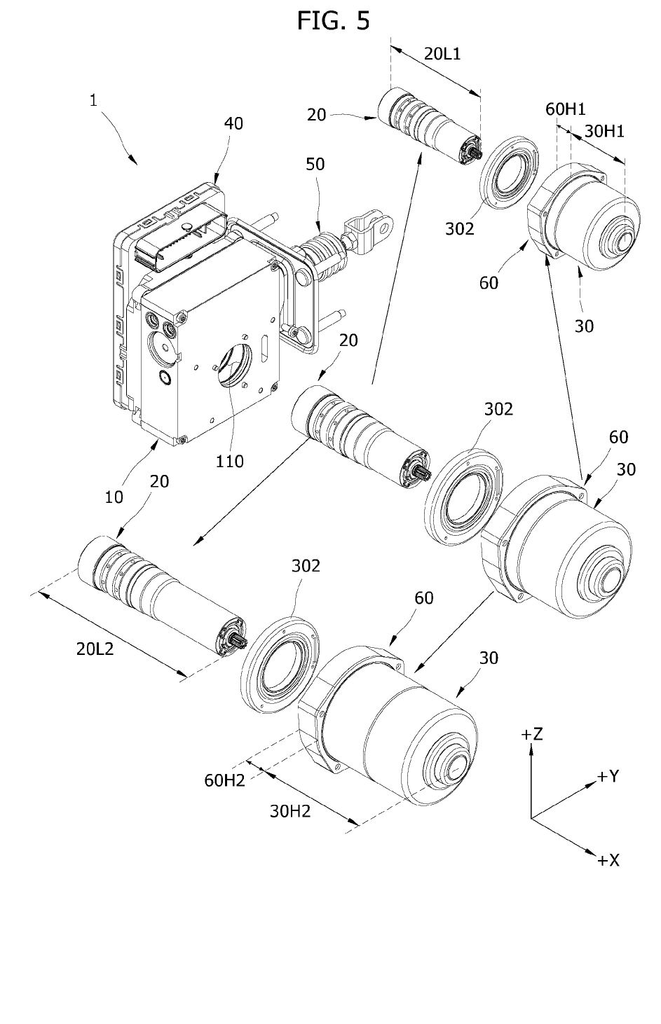

FIG. 5 is a perspective view illustrating the cylinder unit 20, the drive unit 30, and the spacer unit 60 according to various embodiments of the present disclosure.

The cylinder unit 20, the drive unit 30, and the spacer unit 60 will be described with reference to FIG. 5.

The length (e.g., in the X-axis direction) of the cylinder unit 20, the length (e.g., in the X-axis direction) of the drive unit 30, and the length (e.g., in the X-axis direction) of the spacer unit 60 may vary.

In an embodiment, a first cylinder unit length 20L1 of the cylinder unit 20 may be smaller than a second cylinder unit length 20L2 of the cylinder unit 20. A first drive unit height 30H1 of the drive unit 30 may be smaller than a second drive unit height 30H2 of the drive unit 30. A first spacer unit height 60H1 of the spacer unit 60 may be smaller than a second spacer unit height 60H2 of the spacer unit 60.

The length of the cylinder unit 20, the height of the drive unit 30, and the height of the spacer unit 60 may vary to meet specifications of a vehicle to which the brake actuator 1 is mounted.

In an embodiment, in the case where the vehicle to which the brake actuator 1 is mounted has a relatively large weight or requires relatively high braking force, the cylinder unit 20 having the second cylinder unit length 20L2, the drive unit 30 having the second drive unit height 30H2, and/or the spacer unit 60 having the second spacer unit height 60H2 may be provided in the brake actuator 1.

In another embodiment, in the case where the vehicle to which the brake actuator 1 is mounted has a relatively small weight or requires relatively low braking force, the cylinder unit 20 having the first cylinder unit length 20L1, the drive unit 30 having the first drive unit height 30H1, and/or the spacer unit 60 having the first spacer unit height 60H1 may be provided in the brake actuator 1.

More specifically, the length of the cylinder unit 20 may be adjusted to increase or decrease the amount of fluid that is discharged from or introduced into the cylinder unit 20, and accordingly, the height of the spacer unit 60 may be adjusted.

In addition, the height of the drive unit 30 or the diameter (e.g., in a Y-Z plane) of the drive unit 30 may be adjusted to increase or decrease the speed or pressure of fluid that is discharged from or introduced into the cylinder unit 20.

An open support 302 shown in FIG. 5 may be a structure connected to a motor (not shown) disposed in the drive housing 300, and is illustrated separately from the drive housing 300 for ease of explanation.

As described above, only the specifications of the cylinder unit 20, the drive unit 30, and/or the spacer unit 60 may be adjusted to meet the required specifications of the brake actuator 1, without changing the design of other components (e.g., the hydraulic unit 10, the electronic control unit 40, and the pedal unit 50).

In addition, even when a failure occurs in the electronic control unit 40, the electronic control unit 40 may be easily detached from the hydraulic unit 10, thereby improving the maintainability of the brake actuator 1.

Furthermore, the drive unit 30, the electronic control unit 40, and the pedal unit 50 may be disposed on the first side (e.g., in the +X-axis direction), the second side (e.g., in the −X-axis direction), and the third side (e.g., in the +Y-axis direction) of the hydraulic unit 10, respectively, thereby improving the assemblability of the brake actuator 1.

FIG. 6 is a sectional view illustrating the drive unit 30 according to an embodiment of the present disclosure.

The drive unit 30 will be described with reference to FIG. 6.

The drive unit 30 may include the drive housing 300, the opening 301, the open support 302, an open support bearing 303, the drive protrusion 310, a drive protrusion bearing 320, a rotation cover 330, and a motor installation space 340.

The drive housing 300 may be provided in an approximately cylindrical shape, with a first side being closed (e.g., in the +X-axis direction) and a second side being open (e.g., in the −X-axis direction).

The opening 301 may be defined as an open portion of the drive housing 300. In some embodiment, the opening 301 is open toward the hydraulic unit 10.

The open support 302 that is in contact with an inner surface of the drive housing 300 may be disposed in the opening 301.

The open support bearing 303 provided as a bearing may be disposed inside the open support 302.

The drive protrusion 310 may protrude toward one side (e.g., in the +X-axis direction) from a closed portion of the drive housing 300. The drive protrusion bearing 320 provided as a bearing may be disposed inside the drive protrusion 310.

A length (e.g., in the X-axis direction) of the drive protrusion 310 protruding from the drive housing 300 may vary depending on the length (e.g., in the X-axis direction) of the cylinder unit 20.

In an embodiment, as the length of the cylinder unit 20 increases, the length of the drive protrusion 310 may also increase, and as the length of the cylinder unit 20 decreases, the length of the drive protrusion 310 may also decrease.

The rotation cover 330 may be disposed inside the drive housing 300. The rotation cover 330 may be in contact with the open support bearing 303 and the drive protrusion bearing 320. The rotation cover 330 in contact with the open support bearing 303 and the drive protrusion bearing 320 may rotate inside the drive housing 300. In an embodiment, the rotation cover 330 may revolve about its own axis in the drive housing 300.

The rotation cover 330 may include a rotation cover opening 331 and a rotation cover protrusion 332.

An outer surface of the rotation cover opening 331 may be in contact with the open support bearing 303, and an outer surface of the rotation cover protrusion 332 may be in contact with the drive protrusion bearing 320.

An inner surface of the rotation cover protrusion 332 may be in contact with the cylinder unit 20. In an embodiment, the inner surface of the rotation cover protrusion 332 may be in contact with the piston driver 230. The piston driver 230 may be inserted into the rotation cover protrusion 332 and may rotate in response to rotation of the rotation cover 330.

The rotation cover 330 may make contact with the open support bearing 303 and the drive protrusion bearing 320 and rotate relative to the drive housing 300.

A space between the drive housing 300 and the rotation cover 330 may be defined as the motor installation space 340. The motor (not shown) may be disposed in the motor installation space 340. The motor may rotate the rotation cover 330. In an embodiment, a stator (not shown) of the motor may be disposed in the motor installation space 340, and a rotor (not shown) of the motor may be disposed outside the rotation cover 330. As the rotor rotates with respect to the stator, the rotation cover 330 coupled to the rotor may rotate. As the rotation cover 330 rotates, the piston driver 230 coupled to an inner side of the rotation cover protrusion 332 may rotate, and accordingly, the piston 220 may move in a direction parallel to the longitudinal direction (e.g., the X-axis direction) of the cylinder 210.

The fluid that is located in the cylinder unit 20 may be moved by the piston 220. In an embodiment, as the piston 220 moves to one side (e.g., in the +X-axis direction) away from the electronic control unit 40, fluid located outside the cylinder unit 20 may move into the cylinder unit 20. As the piston 220 moves to an opposite side (e.g., in the −X-axis direction) toward the electronic control unit 40, the fluid received in the cylinder unit 20 may move to the outside of the cylinder unit 20.

Alternatively, as the piston 220 moves away from the electronic control unit 40, the fluid received in the cylinder unit 20 may move to the outside of the cylinder unit 20, and as the piston 220 moves toward the electronic control unit 40, the fluid located outside the cylinder unit 20 may be introduced into the cylinder unit 20.

As described above, the flow path of the fluid may vary depending on movement of the piston 220 in a direction (e.g., the +X-axis direction), because the flow path varies depending on a structure of the cylinder (e.g., a single-acting or double-acting structure).

FIG. 7 is a sectional view illustrating a cylinder unit 20 according to a first embodiment of the present disclosure. FIG. 8 is a sectional view illustrating a cylinder unit 20 according to a second embodiment of the present disclosure.

FIGS. 7 and 8 illustrate the cylinder units 20 having different lengths (e.g., in the X-axis direction). A cylinder unit 20 having a greater length may discharge a larger amount of fluid to the outside of the cylinder unit 20.

The cylinder unit 20 will be described with reference to FIGS. 7 and 8.

The cylinder unit 20 may include the cylinder 210, the piston 220, the piston driver 230, an inlet/outlet housing 240, and a sealing component 250.

The cylinder 210 may be shaped to have a hollow interior and may extend in a direction (e.g., the X-axis direction). The piston 220 may be disposed inside the cylinder 210.

The piston 220 may be shaped to have a hollow interior and may extend in a direction (e.g., the X-axis direction). The piston 220 may move in the longitudinal direction (e.g., the X-axis direction) of the cylinder 210. The piston driver 230 may be disposed inside the piston 220.

A first side (e.g., located in the +X-axis direction) of the piston driver 230 may be inserted into the rotation cover 330. In an embodiment, the first side of the piston driver 230 may be inserted into the rotation cover 330 such that the first side of the piston driver 230 comes into contact with the inner surface of the rotation cover protrusion 332. Accordingly, the piston driver 230 may rotate in response to rotation of the rotation cover 330.

A helical piston-driver groove 231, which is recessed to form a concave groove, may be formed in an outer surface of the piston driver 230. The helical piston-driver groove 231 may be provided in the form of a helical groove of a thread.

A piston-driver ball 232 may be seated in the helical piston-driver groove 231. The piston-driver ball 232 may contact a piston-driver moving component 233 disposed on the outer surface of the piston driver 230. As the piston driver 230 rotates, the piston-driver moving component 233 may move parallel to a direction (e.g., in the X-axis direction).

The piston-driver moving component 233 may be connected to the piston 220. As the piston driver 230 rotates, the piston-driver moving component 233 may move parallel to a direction, and accordingly, the piston 220 may also move together with the piston-driver moving component 233.

The inlet/outlet housing 240 may be disposed between the cylinder 210 and the piston 220. The inlet/outlet housing 240 may be disposed to contact both the outer surface and the inner surface of the piston 220. Due to the aforementioned configuration, the volume of space enclosed by the piston 220 and the inlet/outlet housing 240 may vary depending on movement of the piston 220.

In an embodiment, in response to movement of the piston 220 to one side (e.g., in the +X-axis direction), the volume of the space enclosed by the piston 220 and the inlet/outlet housing 240 may increase. In response to movement of the piston 220 to an opposite side (e.g., in the −X-axis direction), the volume of the space enclosed by the piston 220 and the inlet/outlet housing 240 may decrease.

The cylinder unit 20 may further include a cylinder inlet/outlet hole 211 that passes through the cylinder 210, and an inlet/outlet hole 241 that passes through the inlet/outlet housing 240.

The inlet/outlet hole 241 may be in fluid communication with the space enclosed by the piston 220 and the inlet/outlet housing 240 and may be in fluid communication with the cylinder inlet/outlet hole 211.

Accordingly, a reduction in the volume of the space enclosed by the piston 220 and the inlet/outlet housing 240 may cause the fluid to flow from the inside of the cylinder unit 20 to the outside of the cylinder unit 20 through the inlet/outlet hole 241 and the cylinder inlet/outlet hole 211.

In addition, an increase in the volume of the space enclosed by the piston 220 and the inlet/outlet housing 240 may cause the fluid to flow from the outside of the cylinder unit 20 to the inside of the cylinder unit 20 through the cylinder inlet/outlet hole 211 and the inlet/outlet hole 241.

The sealing component 250 may be disposed between the cylinder 210 and the piston 220, and may be disposed between the piston 220 and the inlet/outlet housing 240. Accordingly, fluid leakage between the cylinder 210, the piston 220, and/or the inlet/outlet housing 240 may be prevented.

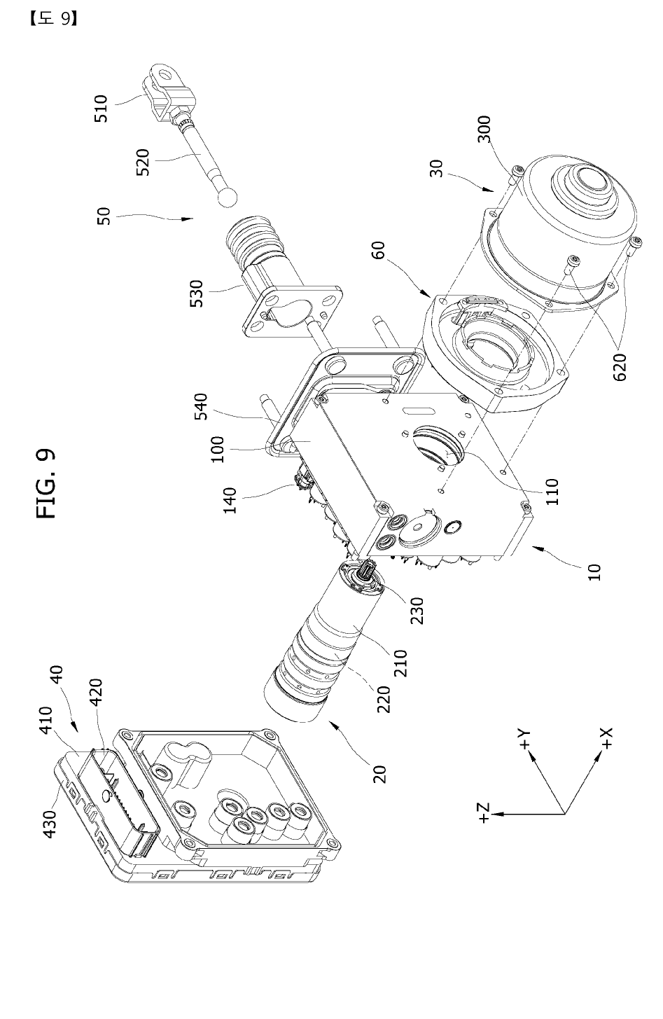

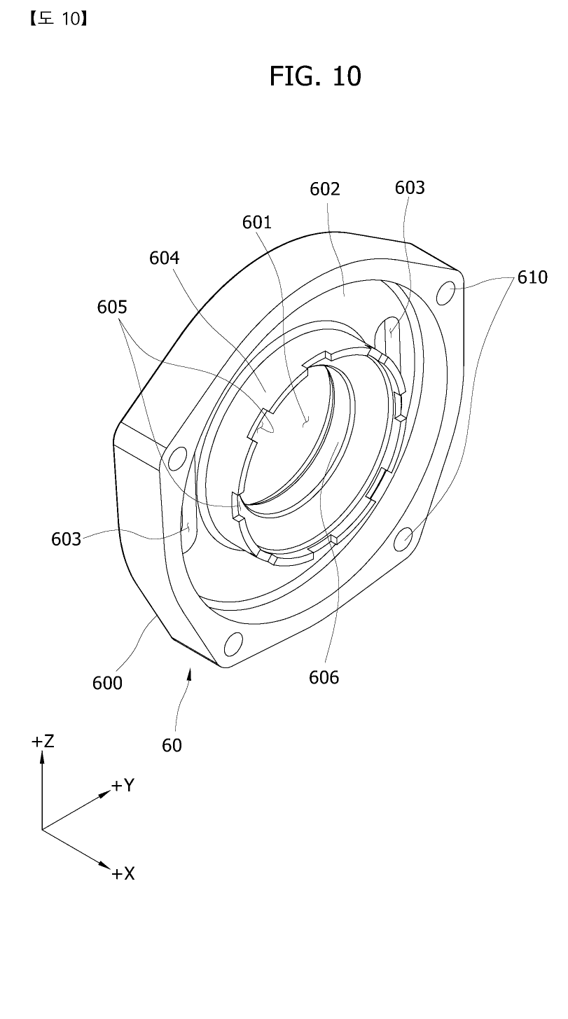

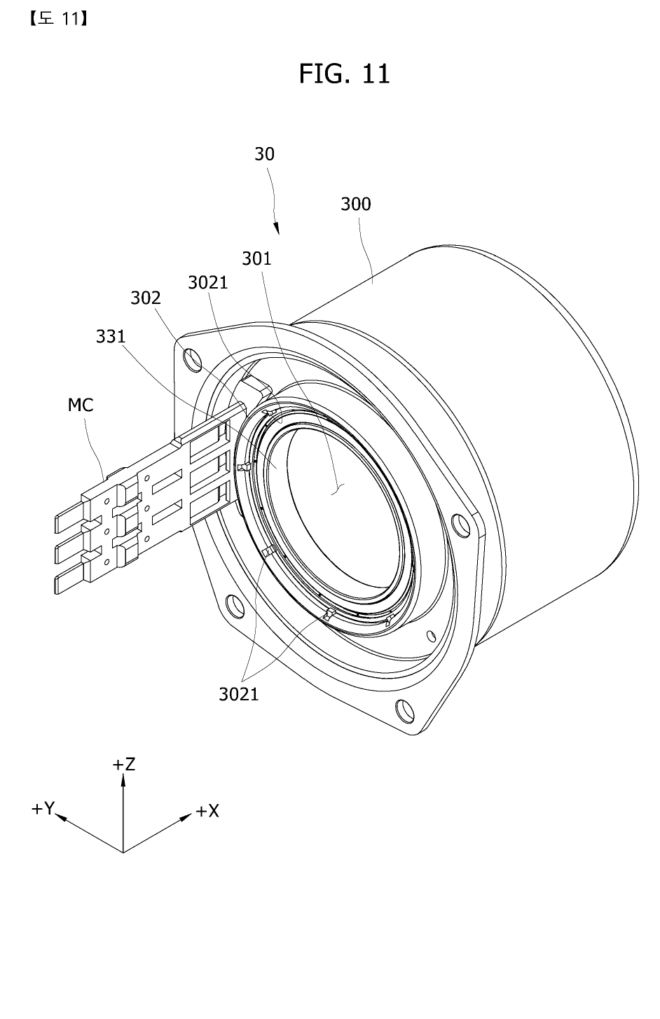

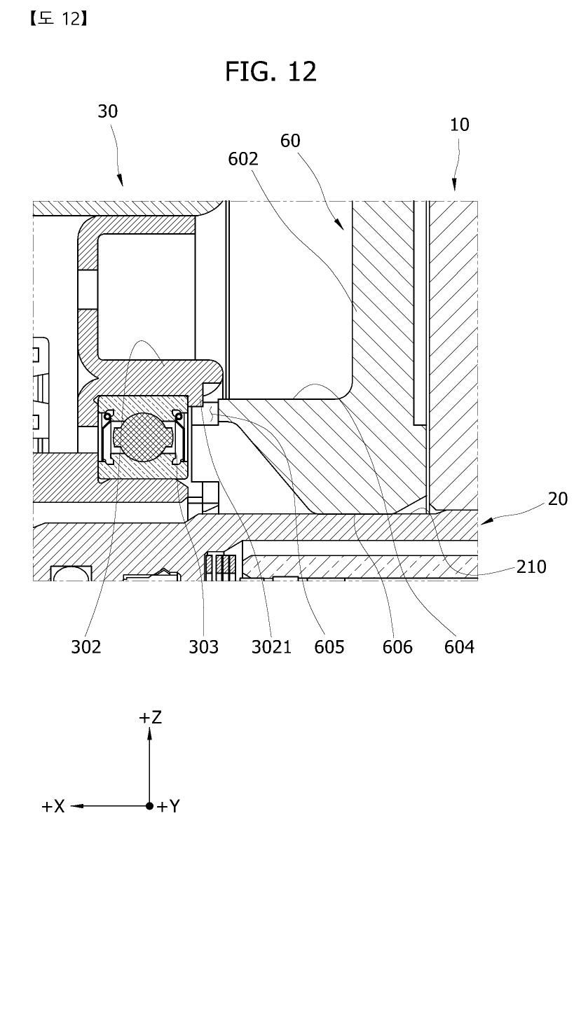

FIG. 9 is an exploded perspective view illustrating a brake actuator including a modified example of a spacer unit according to the present disclosure. FIG. 10 is a perspective view illustrating a modified example of the spacer unit of the present disclosure. FIG. 11 is a perspective view illustrating a modified example of the drive unit of the present disclosure. FIG. 12 is a sectional view illustrating a drive unit combined with a modified example of the spacer unit of the present disclosure.

The drive unit 30 and the spacer unit 60 will be described with reference to FIGS. 9 to 12.

The spacer unit 60 may be disposed between the hydraulic unit 10 and the drive unit 30. The spacer unit 60 disposed between the hydraulic unit 10 and the drive unit may space the hydraulic unit 10 apart from the drive unit 30. A height of the spacer unit 60 (e.g., in the X-axis direction) may have various values and may vary depending on the design of the cylinder unit 20.

The spacer unit 60 illustrated in FIGS. 2 to 5 corresponds to an embodiment that includes the spacer body 600, the spacer body hole 601, the spacer fastening hole 610, and a spacer fastener 620, while the spacer unit 60 illustrated in FIGS. 9 to 12 corresponds to an embodiment that includes a spacer body hole 601, a spacer body connection portion 602, a spacer body terminal hole 603, a spacer body protrusion 604, a spacer body protrusion groove 605, a spacer-body inner contact portion 606, a spacer fastening hole 610, and a spacer fastener 620.

The spacer unit 60 may include the spacer body hole 601 passing through the spacer body 600.

The spacer body hole 601 may be disposed inside the spacer body 600. The cylinder unit 20 may be disposed in the spacer body hole 601. According to an embodiment, the cylinder unit 20 may be inserted into the spacer body hole 601. More specifically, the cylinder 210 may be disposed to pass through the spacer body hole 601.

The spacer unit 60 may include the spacer body connection portion 602 disposed radially outside the spacer body hole 601. The spacer body connection portion 602 may be provided as a plate enclosing the spacer body hole 601.

The spacer unit 60 may include the spacer body terminal hole 603 provided as a hole passing through the spacer body connection portion 602. A motor terminal MC of a motor (not illustrated) may be disposed in the spacer body terminal hole 603 formed in the spacer body connection portion 602. In some embodiments, the space body terminal hole 603 is formed or configured to accommodate the motor terminal MC. The motor terminal MC may be inserted into the hydraulic housing 100 through the spacer body terminal hole 603. The motor terminal MC may be electrically connected to a circuit disposed inside the hydraulic housing 100.

The spacer body terminal hole 603 may be provided as one or more. The spacer body terminal hole 603 may be positioned to correspond to a position at which the motor terminal MC is disposed. The spacer body terminal hole 603 may be disposed radially outside the spacer body hole 601. A shape of the spacer body terminal hole 603 may be provided in the form of an elongated hole.

The spacer unit 60 may include the spacer body protrusion 604 that protrudes from the spacer body 600 toward the drive unit 30. For example, the spacer body protrusion 604 protrudes from the spacer body connection portion 602 of the spacer body 600. The spacer body protrusion 604 may be disposed radially outside the spacer body hole 601. The cylinder unit 20 inserted into the spacer body hole 601 may be enclosed by the spacer body protrusion 604 and may be protected by the spacer body protrusion 604.

The spacer unit 60 may include the spacer body protrusion groove 605 formed as a groove in an end (e.g., in the +X-axis direction) of the spacer body protrusion 604.

The spacer body protrusion groove 605 may be provided to form an embossed-and-recessed shape at the end of the spacer body protrusion 604. The spacer body protrusion 604 including the spacer body protrusion groove 605 may contact the drive unit 30. The spacer body protrusion groove 605 may contact the drive unit 30. According to an embodiment, the spacer body protrusion 604 may engage with the drive unit 30 through the spacer body protrusion groove 605. According to an embodiment, the spacer body protrusion groove 605 may engage with the drive unit 30. More specifically, the spacer body protrusion 604 may contact the open support 302 of the drive unit 30, and an open support protrusion 3021 may be disposed in the spacer body protrusion groove 605.

The open support protrusion 3021 of the drive unit 30 may be disposed in the spacer body protrusion groove 605. More specifically, the open support protrusion 3021 may engage with the spacer body protrusion 604 through the spacer body protrusion groove 605. More specifically, the open support protrusion 3021 may engage with the spacer body protrusion groove 605. As the open support protrusion 3021 engage with the spacer body protrusion groove 605, rotation of the spacer unit 60 with respect to the drive unit 30 or rotation of the drive unit 30 with respect to the spacer unit 60 may be restricted. Furthermore, a position at which the drive unit 30 is coupled to the spacer unit 60 may be specified.

The spacer body protrusion groove 605 may be provided in plurality along a circumference of the spacer body protrusion 604. The open support protrusion 3021 may be provided in plurality along a circumference of the open support 302. Each of the plurality of open support protrusions 3021 may be disposed in a corresponding one of the plurality of spacer body protrusion grooves 605.

As the open support protrusions 3021 engage with the spacer body protrusion grooves 605 as described above, alignment or concentricity (e.g., in a y–z plane) between the drive unit 30 and the spacer unit 60 may be improved.

The spacer unit 60 may include the spacer-body inner contact portion 606 disposed radially inside the spacer body terminal hole 603.

The spacer-body inner contact portion 606 may contact the cylinder unit 20 inserted into the spacer body hole 601. According to an embodiment, the cylinder 210 may be disposed to pass through the spacer body hole 601, and an outer circumference of the cylinder 210 may contact the spacer-body inner contact portion 606. As the outer circumference of the cylinder 210 contacts the spacer-body inner contact portion 606, alignment or concentricity (e.g., in a y–z plane) of the cylinder unit 20 with respect to the spacer unit 60 may be improved. In addition, alignment or concentricity (e.g., in a y–z plane) of the cylinder unit 20 with respect to the hydraulic unit 10 may be improved.

Furthermore, as the cylinder unit 20, the drive unit 30, and/or the spacer unit 60 are interactively coupled to each other, the position of the cylinder unit 20 may not be changed even when an external force is applied to the cylinder unit 20, the drive unit 30, and/or the spacer unit 60.

The drive unit 30 may include the open support protrusion 3021 provided as a protrusion that protrudes from the open support 302.

The open support protrusion 3021 may protrude from the open support 302 and may contact the spacer unit 60. The open support protrusion 3021 may protrude from the open support 302 toward the spacer unit 60. According to an embodiment, the open support protrusion 3021 may be inserted into the spacer body protrusion groove 605 of the spacer unit 60. More specifically, the open support protrusion 3021 may engage with the spacer body protrusion groove 605.

The open support protrusion 3021 may be provided in plurality along the circumference of the open support 302. Each of the plurality of open support protrusions 3021 may be disposed in a corresponding one of the plurality of spacer body protrusion grooves 605.

The present disclosure has been described with reference to embodiments shown in the accompanying drawings, but these are merely illustrative, and those skilled in the art will recognize that various modifications and equivalent embodiments can be made therefrom. Thus, the true technical scope of the disclosure should be defined only by the following claims.

What is claimed is:

1. A brake actuator, comprising:
a hydraulic unit including a cylinder hole extending in a first direction, and a hydraulic circuit provided in the hydraulic unit;
a cylinder unit including a cylinder disposed to pass through the cylinder hole, and a piston configured to move inside the cylinder;
a drive unit disposed on a first side of the hydraulic unit, the drive unit configured to control the piston; and
an electronic control unit disposed on a second side of the hydraulic unit.

2. The brake actuator as claimed in claim 1, wherein the hydraulic unit further includes a pedal hole extending in a second direction different from the first direction, and
wherein the brake actuator further comprising a pedal unit configured to be inserted into the pedal hole.

3. The brake actuator as claimed in claim 2,
wherein the pedal unit comprises a pedal stroke inserted into the pedal hole and configured to move in the pedal hole, and
wherein the hydraulic unit comprises a stroke sensor configured to detect a position of the pedal stroke.

4. The brake actuator as claimed in claim 1, further comprising a spacer unit disposed between the drive unit and the hydraulic unit and configured to provide a space between the drive unit and the hydraulic unit.

5. The brake actuator as claimed in claim 4, wherein the spacer unit comprises:
a spacer body disposed between the drive unit and the hydraulic unit;
a spacer fastening hole passing through the spacer body; and
a spacer fastener passing through the drive unit and the spacer fastening hole, the spacer fastener configured to be inserted into the hydraulic unit.

6. The brake actuator as claimed in claim 5, further comprising:
a spacer body terminal hole configured to accommodate a motor terminal;
a spacer-body inner contact portion disposed inside the spacer body terminal hole and contacting the cylinder unit; and
a spacer body connection portion connecting the spacer body and the spacer body terminal hole.

7. The brake actuator as claimed in claim 6, further comprising:
a spacer body protrusion protruding from the spacer body connection portion toward the drive unit; and
a spacer body protrusion groove formed as a groove in the spacer body protrusion and configured to engage with the drive unit.

8. The brake actuator as claimed in claim 4, wherein the drive unit comprises:
a drive housing including an opening that is open toward the hydraulic unit; and
a motor disposed in the drive housing.

9. The brake actuator as claimed in claim 8, wherein the drive unit further comprises:
a drive protrusion disposed to protrude from the drive housing; and
a drive protrusion bearing disposed in the drive protrusion, and configured to contact the cylinder unit.

10. The brake actuator as claimed in claim 8, further comprising:
the opening configured to accommodate the cylinder unit;
an open support bearing disposed radially outside the opening;
an open support disposed radially outside the open support bearing and configured to support the open support bearing;
an open support protrusion protruding from the open support toward the spacer unit and engaging with the spacer unit.
